(19) United States
(12) Patent Application Publication
(10) Pub. No.: US 2015/0347489 A1
(43) Pub. Date: Dec. 3, 2015

(54) INFORMATION RETRIEVAL SYSTEM AND METHOD BASED ON QUERY AND RECORD METADATA IN COMBINATION WITH RELEVANCE BETWEEN DISPARATE ITEMS IN CLASSIFICATION SYSTEMS

(71) Applicant: Scott David Sherwin, Chicago, IL (US)

(72) Inventor: Scott David Sherwin, Chicago, IL (US)

(21) Appl. No.: 14/675,711

(22) Filed: Mar. 31, 2015

Related U.S. Application Data
(60) Provisional application No. 61/973,202, filed on Mar. 31, 2014.

(51) Int. Cl. G06F 17/30; G06Q 50/18

(52) U.S. Cl. CPC G06F 17/30345; G06F 17/30867; G06F 17/30528; G06Q 50/184

(57) ABSTRACT

An information retrieval system that interprets a query and determines a rank or score for selected records is disclosed herein, where the rank or score is based partly on determining the relevance between disparate items in a classification system. The query can be expanded by utilizing metadata about the query, which results in one or more query values for comparison. Depending on the type of records that are to be ranked or scored, different characteristics of the selected records will be extracted, optionally expanded, and then converted into record values for comparison. The query values and record values, which are part of the same classification system, can then be scored based on the relevance between these values in this classification system. Results can be weighed, or the final record score can be weighed. Finally, records are displayed to the user in final rank or score order.

### PRIORITY, BENEFIT, AND INCORPORATION BY REFERENCE

This application claims the benefit and priority of U.S. Provisional Patent Application No. 61/973,202, entitled “Information retrieval system and method based on query and record metadata in combination with relevance between disparate items in classification systems,” filed on Mar. 31, 2014. The full disclosures from this provisional application are incorporated herein by reference in their entirety.

### DESCRIPTION

### Copyright Notice

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to this document: Copyright © 2013-2015 to the inventor.

### TECHNICAL FIELD

Various embodiments of the present invention relate to systems and methods for analyzing patents, analyzing data about patent experts, attorneys, and clients, evaluating and comparing patent cases, individuals, and patent applications, and their associated patents, experience, and area of technology, to relevant individuals, including patent expert consulting witnesses, patent expert testifying witnesses, patent prosecution attorneys, patent litigation attorneys, patent licensing attorneys, and in-house attorneys.

### BACKGROUND

Lawsuits. When a patent infringement lawsuit is filed in a U.S. Federal district court—generally classified as an 830 cause of action—numerous individuals are often involved in the process of resolving the dispute. These individuals include: the patenee (and their in-house and outside lawyers), the accused infringer (and their in-house and outside lawyers), independent experts (consulting and/or testifying on an issue relevant to the lawsuit who represent both the patentee(s) and the accused infringer(s)).

Licensing. In addition, when a patentee is seeking to sell or license one or more of its patents, numerous individuals are often involved in the transaction. These individuals include: patent licensing attorneys and independent consulting experts.

Prosecution. Further, when an inventor seeks to file a patent application, she often seeks to hire a patent agent, patent attorney, or a technical consultant to help her draft the patent application, assist on related technical issues, and advise her on the patent prosecution process.

Hiring. Additionally, when a company seeks to hire an attorney to assist the corporation with patent matters (for example patent litigation, patent prosecution, and patent licensing) numerous individuals are often interviewed for the position. These individuals include law students, patent agents, patent attorneys, and attorneys with patent experience.

Current methods. The process of finding the right individuals to assist with the above mentioned patent matters presently requires considerable effort and time. Presently, individuals maintain their own list of potential individuals for these positions, ask their colleagues for recommendations, or hire a search agency to help them identify appropriate candidates. All of these present solutions include significant drawbacks, including relying on an extremely limited number of individuals, taking significant amount of time to receive new recommendations, and requiring overhead time and effort to get into contact with the appropriate individuals.

There are no tools that efficiently associate individuals with the requisite background to patent applications, patent licensing deals, patent job openings, or patent cases based on an input that only needs to include the patent number(s) involved in each of these activities. For example, prior art patent U.S. Pat. No. 8,126,886, entitled “System, method, and software for researching, analyzing, and comparing expert witnesses” only discloses users entering queries regarding experts based on name or subject matter and filtering search results based on damage awards, case types, attorneys, clients and date range.

As another example, U.S. Pat. No. 8,412,564, entitled “System and method for identifying excellence within a profession” discloses a system and method for finding relevant individuals creating by creating a candidate pool, evaluating individuals within the candidate pool, conducting peer evaluations of individual candidates in candidate pools defined by professional group and/or sub-group 16, and determining a final selection of individual candidates that demonstrate excellent performance within a particular classification of the professional group and/or subgroup. The focus is on identifying the correct professional sub-groups for each candidate when evaluating individuals with independent research, which helps perform a more accurate peer evaluation process, as professional sub-group classifications may be used to further refine selection of the proper peer evaluators.

### SUMMARY

Systems, methods, and interfaces for researching, evaluating, and comparing patent data related queries to relevant individuals are presented in the areas of: patent litigation, patent licensing, patent prosecution, patent attorney hiring, prior art discovery, invention discovery, and potential infringer discovery. However, such systems, methods, and interfaces may be used in other areas of interest as well.

One example involves finding an appropriate list of potential experts to assist a party in the course of a patent litigation.

Query. The disclosed system, method, and user interface may allow a user (for example an in-house patent counsel or private practice patent attorney) to enter the number of the patent-in-suit, in this example referred to as a query. Based on this query alone, a module may expand this query to include other relevant and related patents. After the query is expanded a module may convert the patent(s) into CPC codes, which may be based on the cooperative patent classification (CPC) system. Alternatively, a module may convert values to any of the other widely available classification systems, such as the United States patent classification system (USPC), the International Classification system (IC), the European Classification system (EC), etc.

Record. In addition, a module may analyze data about experts that are stored in a database, in this example referred to as a record. For example, the record may contain the fact that an expert participated in prior patent litigations. Data associated to these expert witness records may include, for example, case name, date of filing, date of closing, case number, district, judge, and patents-in-suit. In this example, a module may expand the record by expanding the patents-in-suit to include other relevant and related patents. A module may then convert the patent(s) into CPC codes.

Scoring. In this same example, a module may use the CPCs associated to the query and CPCs related to the records. A module may then score each query CPC to each record CPC for each record to transform this relationship between these two CPC values into a score for each record CPC. Optionally, this module may also be modified to generate different scores by a user because their expert opinion may be necessary to take into account how related each query CPC is to each record CPC.

Weighting scores. After a module may calculate a score for each query CPC to each record CPC, a module may weigh the score. In some embodiments, weighting may occur during or prior to such calculations. A score may be giving an adjusted weight if there is reason to believe that this particular query CPC and record CPC relationship is more or less relevant to the initial query. Examples of instances of weighting include: increasing the score because there are primary query CPCs (X values) or primary record CPCs (X values), increasing the score because the source of the CPC value (for example from a patent in a case or a patent that the expert is a named inventor on), or decreasing the results because of the opposite of the above or expert indicated a lower level of experience with a patent. Optionally, this module is also capable of being modified by a user because their expert opinion may be necessary to take into account how much weight any of the above factors should be given.

Score the records. After a module may calculate a score for each query CPC to each record CPC, a module may score each record and then, optionally, all of the records. For example, this may require the above mentioned modules to perform the above mentioned functions of scoring the CPC pairs and weighting the CPC pairs for each record and then all of the records until the above described modules determine that each relevant record has been scored.

Display the results. Another module may display the results of each, or a relevant subset, of the records and metadata about the records. For example based on the search query and any additional filters applied to the query or applied to the results, a module may display the top records and metadata associated to these records. The system may also intentionally delay displaying the results, because a user may perceive that the search was conducted thoroughly and accurately due to such a delay.

### BRIEF DESCRIPTION OF THE DRAWINGS

FIG. 1 is a diagram illustration of an embodiment showing a search system.

FIG. 2 is a list of the major modules of an embodiment showing a search system.

FIG. 3 is a flowchart illustration of an embodiment showing a method that may be performed on a query and record values to determine a CPC score.

FIG. 4 is a detailed flowchart illustration of an embodiment showing a method that may be performed on a query and record values to determine a CPC score.

FIG. 5 is a flowchart illustration of an embodiment showing a method that may be performed to determine a max CPC score.

FIG. 6 is an illustration of an embodiment of a user interface that may be used for inputting a query into the system.

FIG. 7 is an illustration of an embodiment of a user interface that may be used if there is an invalid query entered into the system.

FIG. 8 is a table of an embodiment of the structure that may be used for determining a CPC from a patent query and an identification of the data structures used in one embodiment to weight the score.

FIG. 9 is a table of an embodiment of the structure that may be used for determining a CPC from a record.

FIG. 10 is a table of an embodiment of the structure that may be used for determining a CPC from a patent query record patent number and an identification of the data structures that may be used in one embodiment to weight the score.

FIG. 11 is an illustration of an embodiment of a user interface that may be used for the record results and an identification of the record parameters items that may be used to determine the arrangement of the results.

FIG. 12 is an illustration of an embodiment of a user interface that may be used for the record results and an identification of the record data parameters that may be used to display these results.

FIG. 13 is an illustration of an embodiment of a user interface that may be used for the record results and an identification of the record data parameters that may be used to display these results.

FIG. 14 is a flowchart illustration of an embodiment showing a method that may be performed on two CPC values to determine a CPC score.

FIG. 15 is a diagram illustration of an embodiment showing a method that may be performed on two CPC values to determine a CPC score.

FIG. 16 is a diagram illustration of an embodiment showing a method that may be performed on two CPC values to determine a CPC score.

FIG. 17 is a flowchart illustration of an embodiment showing a method of analyzing attorney, case, and patent data (top) and an embodiment of a database schema showing how case, attorney, and patent data can be stored in a database so it can later be retrieved and then analyzed.

FIG. 18 is a diagram illustration of an embodiment showing a system and method of a search system, which may be integrated with a report generation module, email module, billing module, and a frontend user website.

### DETAILED DESCRIPTION OF THE EXEMPLARY EMBODIMENT(S)

The following detailed description describes one or more specific embodiments of one or more inventions. These embodiments, however, are only offered to exemplify and teach the inventive subject matter. They are not intended to limit the scope of the claimed invention in any manner. These embodiments are shown and described in sufficient detail to enable those skilled in the art to implement or practice the various embodiments of the invention. Thus, the description may omit certain information that is well known to those of skill in the art.

The following detailed description includes numerous specific embodiments of the query, records, and scoring parameters, along with other specific embodiments of the present invention. These various embodiments may be combined with features of other embodiments to yield other embodiments not expressly described in this section.

The processes, graphical user interfaces, and data sets shown and/or described herein are generally stored in a machine readable medium, such as an electronic, optical, magnetic, or ferromagnetic medium, as coded program instructions and/or data. These machine readable media may be used in combination with one or more processors within a single computing or data processing module or within multiple modules that are interlinked, for example via a local or wide-area network, including the Internet.

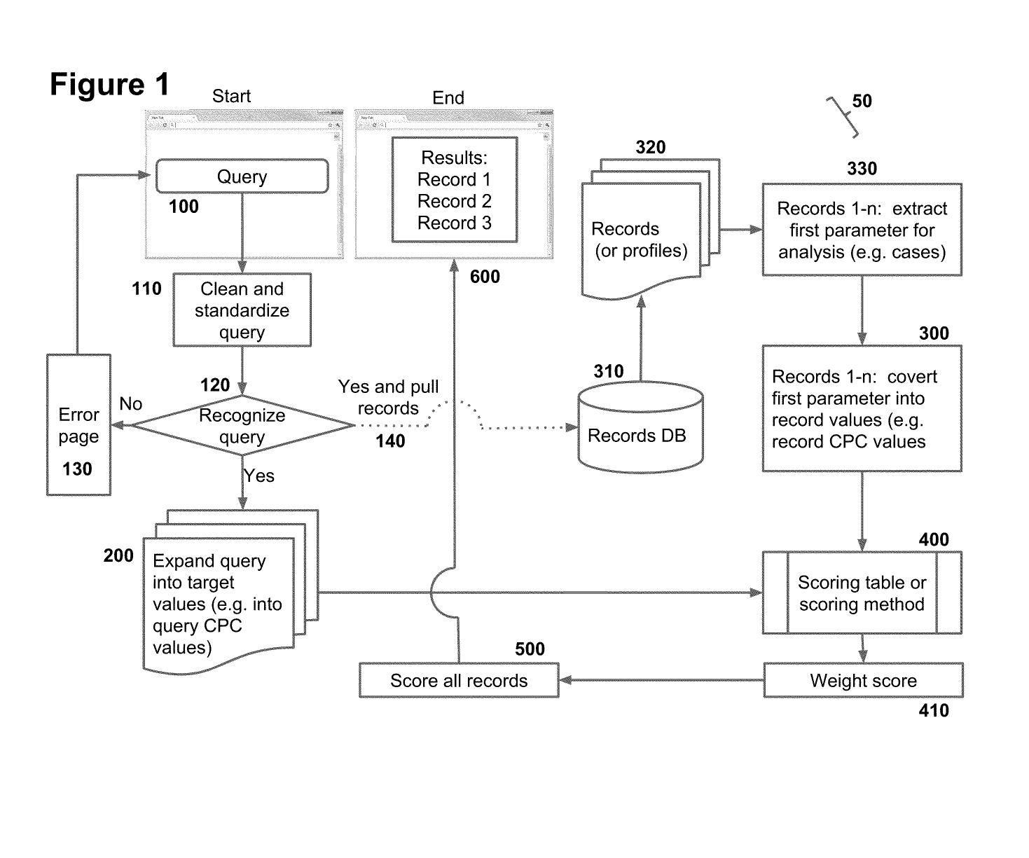

FIG. 1 is a diagram illustration of an embodiment showing a search system (50) and the below description describes the use of that search system with a patent number as the query (101) and the experts as the records (320). In Module 1 a user may enter a patent number (query) on web page (100), which may be connected to a web server, application server, and databases. This user may be a lawyer, or their agent, looking to hire an expert witness, a consultant seeking to find the best expert for a project, or an administrator seeking to perform maintenance on the system. After a module receives the query, in the same or a different module, the query (101) may be transformed into a cleaned and standardized query (110). This may include removing commas, prefixes (e.g. U.S. Pat. No.), suffixes (e.g. B1), and any other data that the system may not recognize as a properly formatted query. A module may format the recognizable information into a standardized format so it can be utilized by other processes in the system. A module may attempt to recognize the query (120). During this process, a module may compare the input query (101) to all possible query values that are stored in the system's memory.

If the cleaned and standardized query (110) is not found in the system, then a module may return an error page (130). This may inform the user that his or her query (101) was not recognized. In addition, a module may create an error log (131) for this query with metadata about the query (101), the cleaning and standardizing process (110), or other data such as the time or user so an administrator may determine why the system could not recognize the query (120).

After a module may recognize the cleaned and standardized query (110), then a module may send a signal to Records DB (140) so that Records DB (140) may begin a process of preparing the records for analysis by a module. This process is discussed in more detail herein, such as below in Module 3.

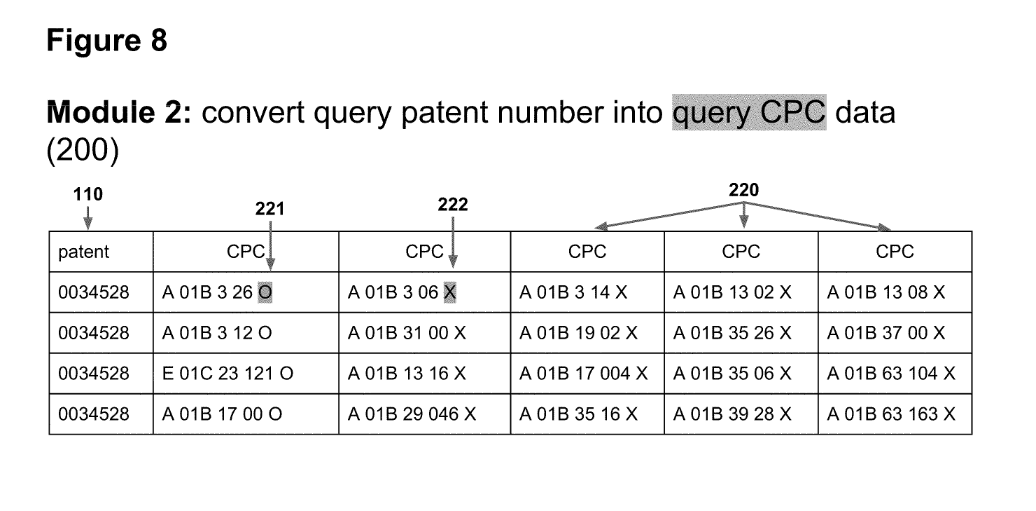

In addition to sending a signal to the signal to Records DB (140), Module 2 may convert a patent number into query CPC data (200). A module may utilize a patent to CPC converter module (210) to calculate the most accurate query CPC values (220) from the cleaned and standardized query (110). During this process, a single patent number may be determined to be relevant to multiple query CPC values (220). The weight for each of these query CPC values (220) may be impacted by primary CPC values (221), secondary CPC values (222), or both. One embodiment of this process is described below in FIG. 8.

After a module may recognize the query (120), and in addition to a module associating the query to one or more than one query CPC value (220), as discussed above, Module 3 may convert records into record CPC data (300).

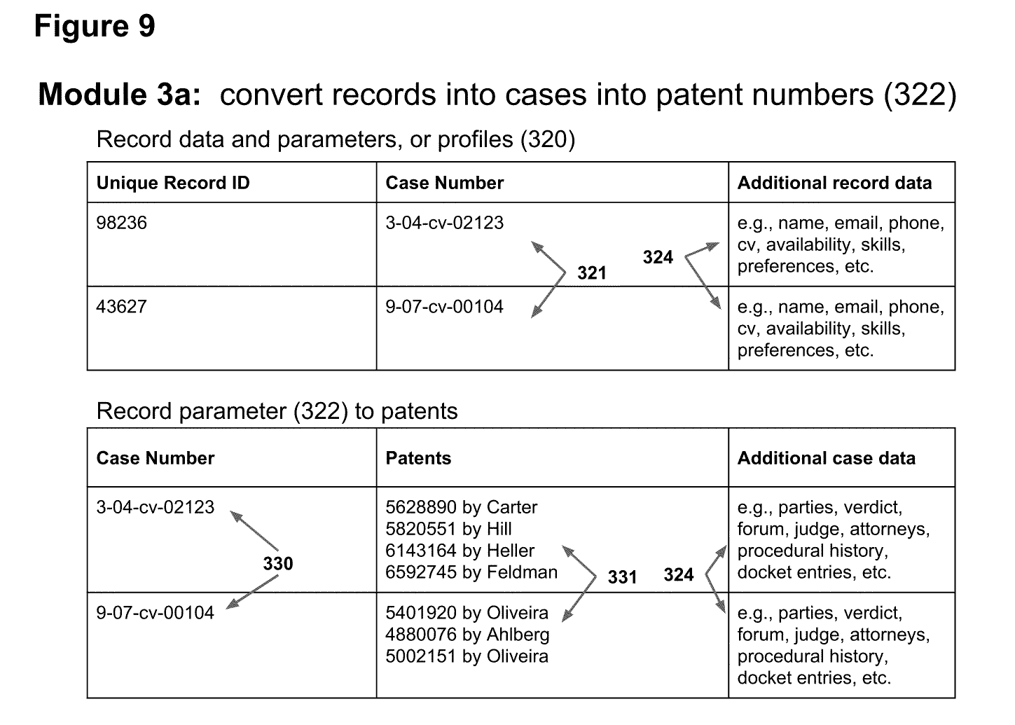

The records (320) may be stored in one or more records database (310). The records contain information about the individuals that a module may transform into scores. For example, such information may be obtained from data that may be commonly referred to as profiles by those skilled in the art. Each record (320) may contain numerous pieces of information, some of which may be used in this scoring process, some of which may be used to display the results, and some of which may not be used as part of this process. In this embodiment, a module may extract (or utilize) the case number (330), which may be one of many possible record parameters (321). An example of this feature is shown in more detail in FIG. 9. A case number may be a number provided to each federal patent litigation by each federal district court or it may represent other sorts of transactions or activities involving patents (e.g., licensing, due diligence). An example of such a case number is 2:13-cv-04430. Each case number may also be associated to the federal district court for that case. For example, a case number may be associated with the Illinois Northern District, such as through the use of the abbreviation “ILND”. Case numbers and federal district court identification data may be obtained via Pacer & cm/ecf or through other databases.

Once a module may extract (or utilize) the case number (330), which may be a record parameter (321), a module may convert this parameter into one or more than one record CPC values. In this example, the records (320) may contain cases, which may be a record parameter (322), and a module may convert these cases into patent numbers (322), and these determined record patents (331) may then be converted into record CPC values (323). An example of this process is shown in more detail in FIG. 9.

Once a module may identify these record CPC values (323), a module may score them to the query CPC values (220) via Module 4: score query CPC data to record CPC data (400).

A module may score each query CPC value (220) to each record CPC value (323) via a process based on the relevance between these two values. In one embodiment, a module may look up this relevance in a CPC table (401), if that relevance was determined at a time before the query was entered and the system was programmed to save a relevance between CPC pairs in a database.

A module may not rely on a CPC table (401), instead a module maybe capable of using a CPC scoring method (402) to determine the raw score for the CPC pair (501).

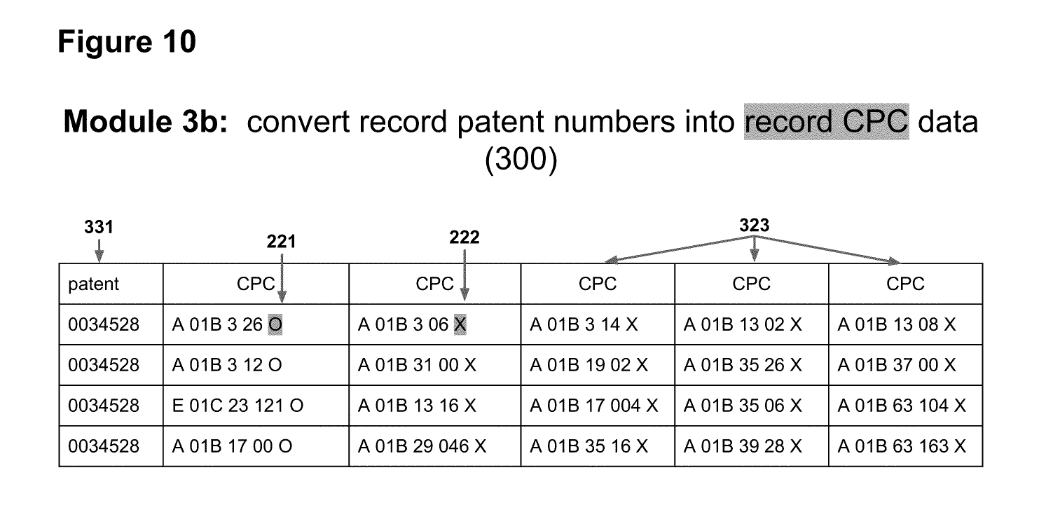

This raw score may then be modified and converted into a weighted score (410) based on numerous features about that particular CPC pair. An example of this will be discussed in reference to FIGS. 8 and 10.

All of the weighted scores (410) for a record (320) may then be compared in Module 5, which may determine a final score for each record (500) to determine a final record score (502). This final record score (502) may be the largest weighted score determined in module 410, or it may involve a weighting of all of the determined scores in module 410 based on the characteristics of those scores.

Once a final score for each record (320) may have been determined, a module may pull record metadata (324), which may also include case metadata (332), and may output that data to the user's browser via an application server and web server in Module 6, which may return records in score order (600).

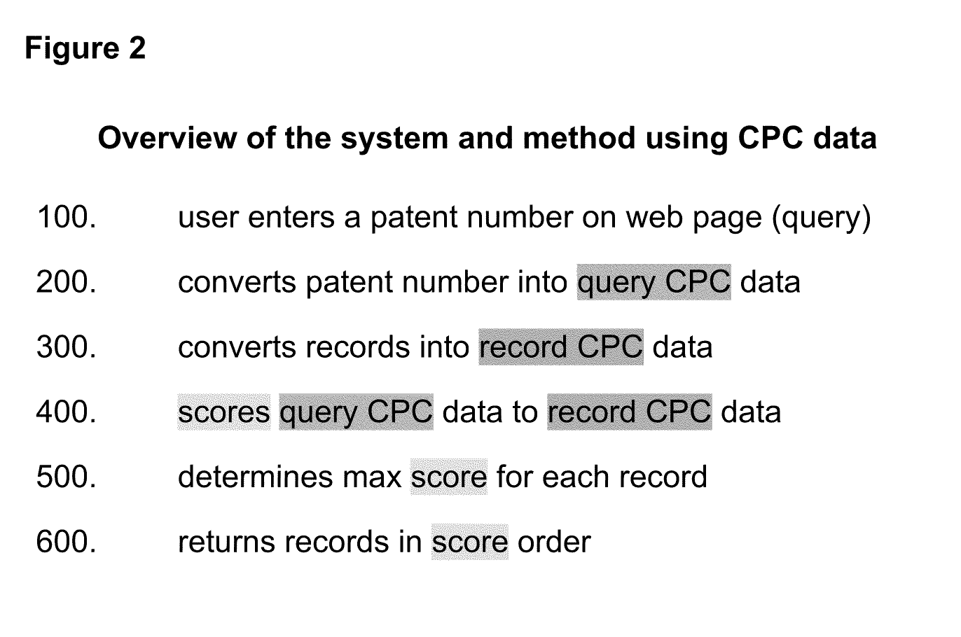

FIG. 2 is a list of the major modules of an embodiment involving entering a query, using one or more modules to determine the best expert witness, and then viewing results about the best expert witnesses. Module 1: user may enter a query (patent number) on web page (100). Module 2: may convert patent number into query CPC data (200). Module 3: may convert records into record CPC data (300). Module 4: may score query CPC data to record CPC data (400). Module 5: may determine a final score for each record (500). Module 6: may return records in score order (600).

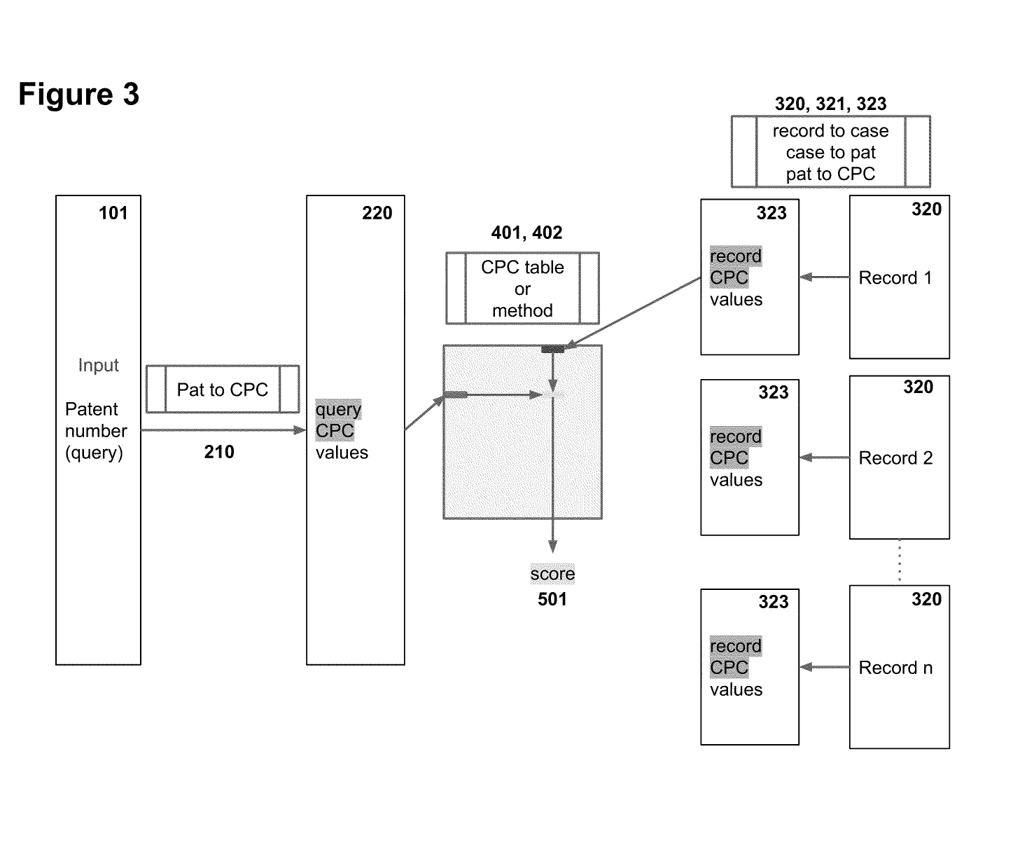

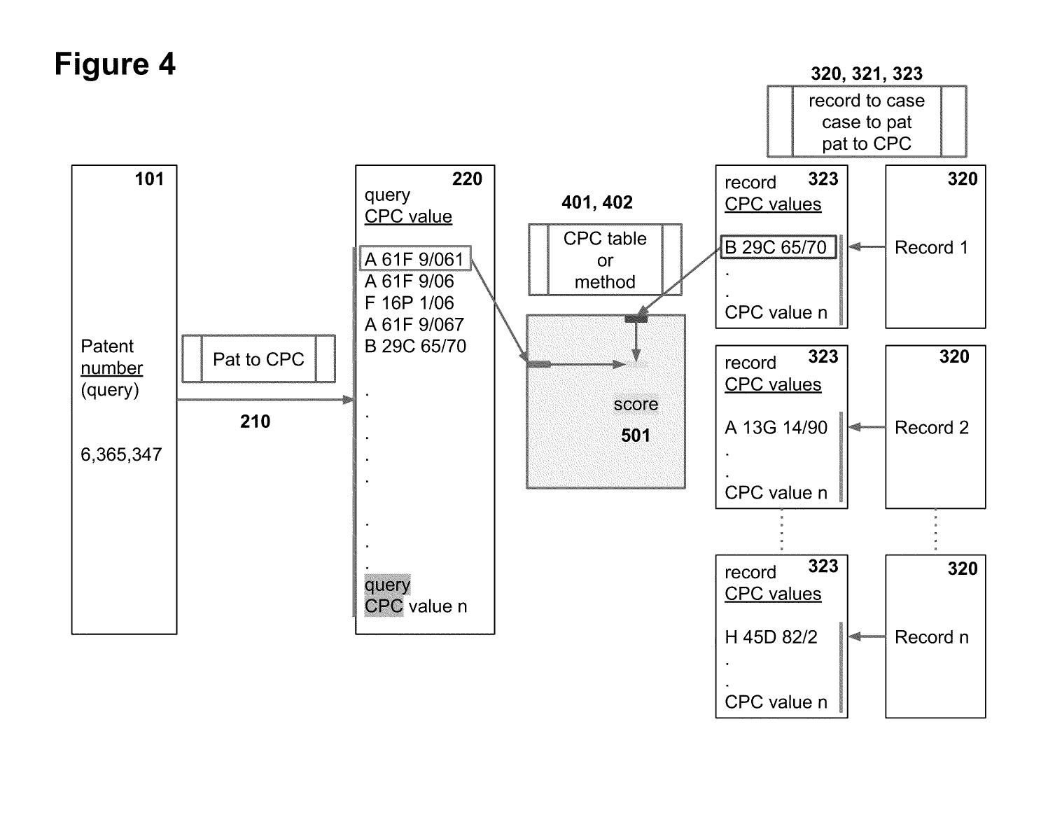

FIGS. 3 and 4 are flowchart illustrations of an embodiment showing a method that may be performed on a query (101) and record values (323) to determine a CPC score (501). In this embodiment, the query (101) may be a patent number and via a patent to CPC converter (210), it may be converted into numerous CPC values (220).

In addition, records (320) may be extracted (or analyzed) from the records database (310). The record profiles (320) may contain record parameters (231) for analysis, which in this embodiment are cases. The cases parameter may then be converted into patent numbers (322). From these patents, record CPC values (323) may be determined.

A module may compare each query CPC value (220) with each record CPC value (323) to generate a raw score (501).

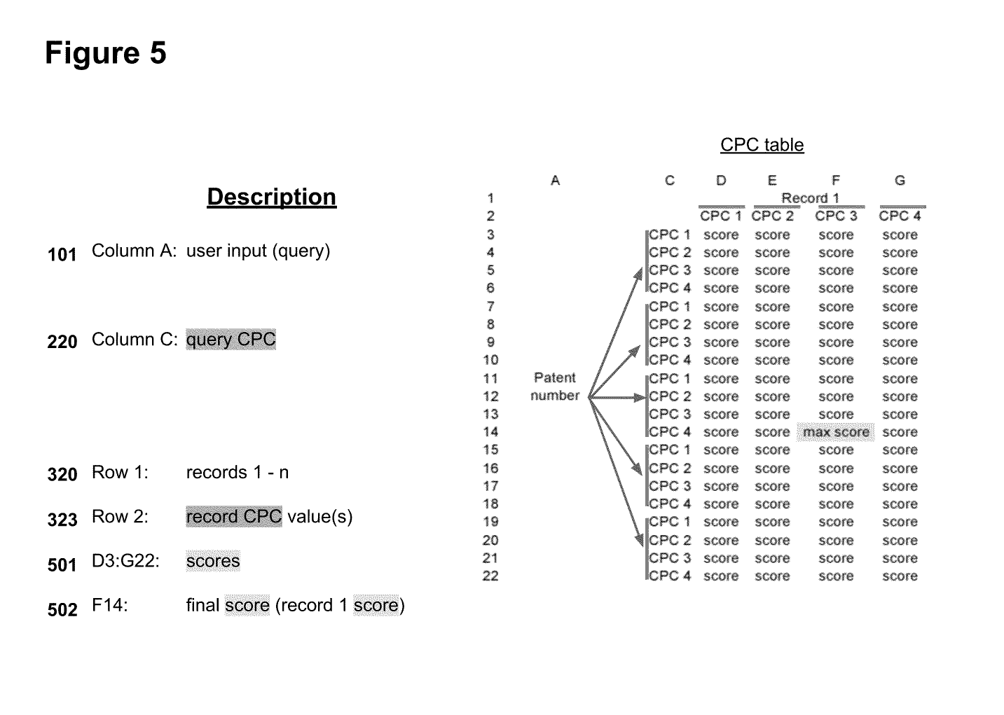

FIG. 5 is a flowchart illustration of an embodiment showing a method that may be performed to determine a final (or max) record score (502). A query (101) may be converted to a query CPC (220). The CPC values (323) may be extracted from each record (320). A raw score may then be determined by each query CPC and record CPC pair (see D:3) (501). In this embodiment, a module may not weigh these raw scores (501). In this embodiment, a module also may not determine a final score based on the collection of scores, but instead a module may determine the final score (502) by using the maximum score among all of the calculated scores (501) for the first record (320).

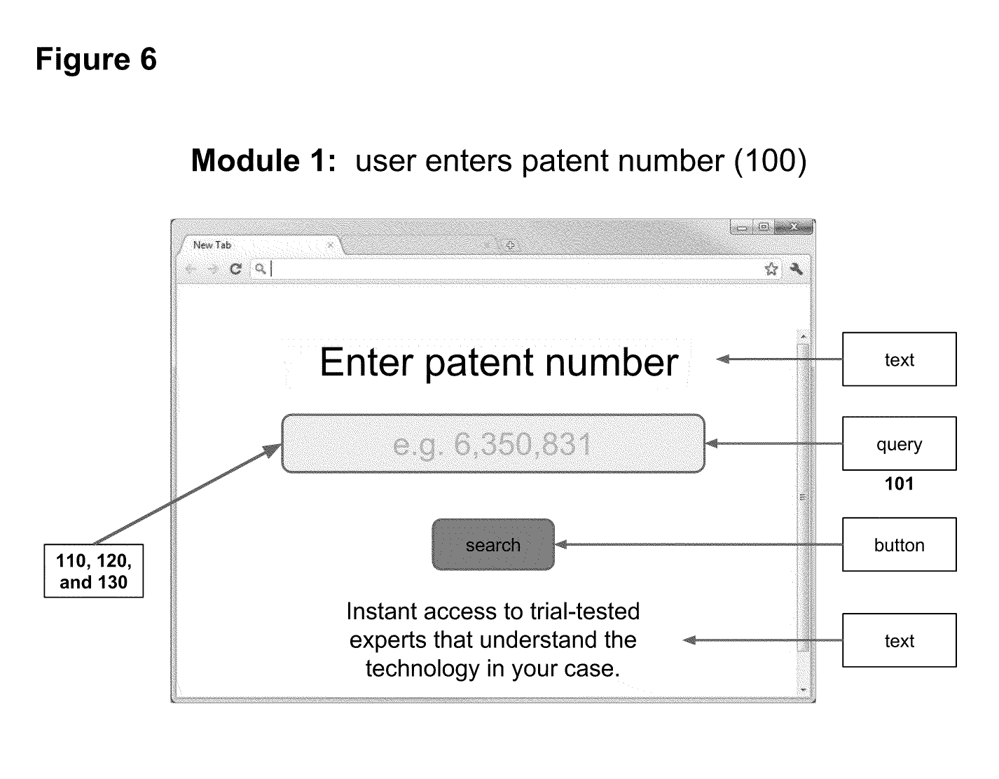

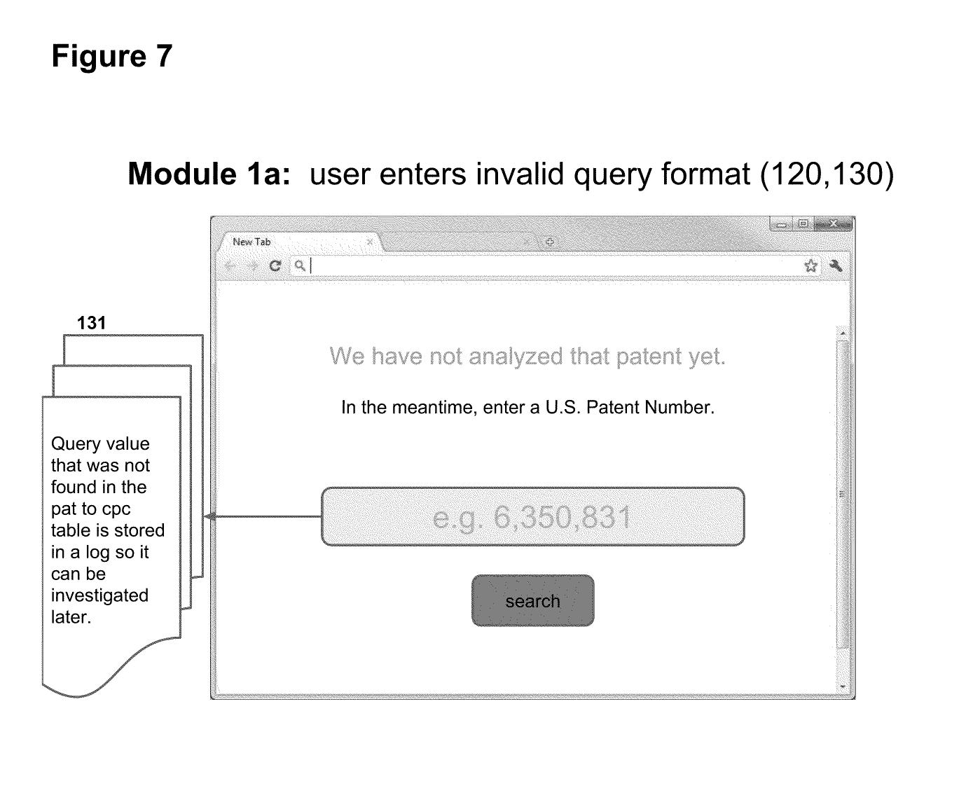

FIG. 6 is an illustration of an embodiment of a user interface that may be used for inputting a query into the system. After a query (101) is submitted, a module may transform the query into a cleaned and standardized query (110). Also during this process, a module may attempt to recognize the query (120). If the query is recognized, then a module may proceed to score the records to determine the most relevant records. But, if the record is not recognized, then a module may proceed to return an error page as described in reference in FIG. 7.

FIG. 7 is an illustration of an embodiment of a user interface that may be used if there is an invalid query entered into the system. After a module may attempt to recognize the query (120), if the record is not recognized, then a module may proceed to return an error page (130). If this occurs, then a module may perform a variety of functions at the web server or application server level, such as storing the initial query (101) and the clean and standardized query (120) in an invalid query database. This information may be stored along with other information, if available, such as date, time, web browser cookie data, user biographical information, and system status/version information.

FIGS. 8 and 10 are tables of an embodiment of the structure that may be used for determining a CPC from a patent query and an identification of the data structures that may be used in one embodiment to weight the score. This visualization is useful for understanding Module 2, which may convert a patent number into query CPC data (200) and Module 3, which may convert records into record CPC data (300) and a module that may weight scores (410). In this example, the query (110) is a patent number. The associated CPC values (220) or record CPC values (323) are shown in this table of this example. In addition to the CPC values (220), the table of this example also includes the primary CPC value (221) indicator—an O—and the secondary CPC value (222) indicator—an X.

These indicators may be used by a module for weighting scores (410) to determine whether the raw score (501) should be adjusted up or down based on the correspondence between the primary CPC value (221) indicator and the secondary CPC value (222) indicator for the query CPC value (220) and the record CPC values (323). For example, if the query CPC value (220) is associated to the primary CPC value (221)—an O—and the record CPC value (323) is also associated to the primary CPC value (221)—an O—then this CPC pair is an OO. In this embodiment, this combination may result in an increase of the CPC pair score (501).

Alternatively, if the query CPC value (220) is associated to the secondary CPC value (222)—an X—and the record CPC value (323) is also associated to the secondary CPC value (222)—an X—then this CPC pair is an XX. In this embodiment, this combination may result in an decrease of the CPC pair score (501). If this combination is an OX, or an XO, then a module may increase the CPC pair score (501), decrease the score, leave the score unchanged, or do something different for each combination.

FIG. 9 is a table of an embodiment of the structure that may be used for determining a CPC from a record. These two tables show an example of a visualization of a module that may convert a parameter to patent (322), then may extract parameter for analysis (e.g. cases) (330), and then may convert cases to patents, which may then be converted to record CPC values (323). In these tables of this example, the record parameter (321) is patent litigation cases from federal district courts. Although not used in this example, the records may also contain record metadata (324), such as metadata described elsewhere herein. This data can include any type of data that may be associated to the record, which in this embodiment is an expert witness. The second table of this example is a visualization of converting the record parameter to a patent, where the extracted parameter for analysis (e.g. cases) (330) is used to determine the associated record patents (331). Although not used in this example, the cases may also contain record metadata (324), such as metadata described elsewhere herein. This data can include any type of data that may be associated to the record, which in this embodiment are cases.

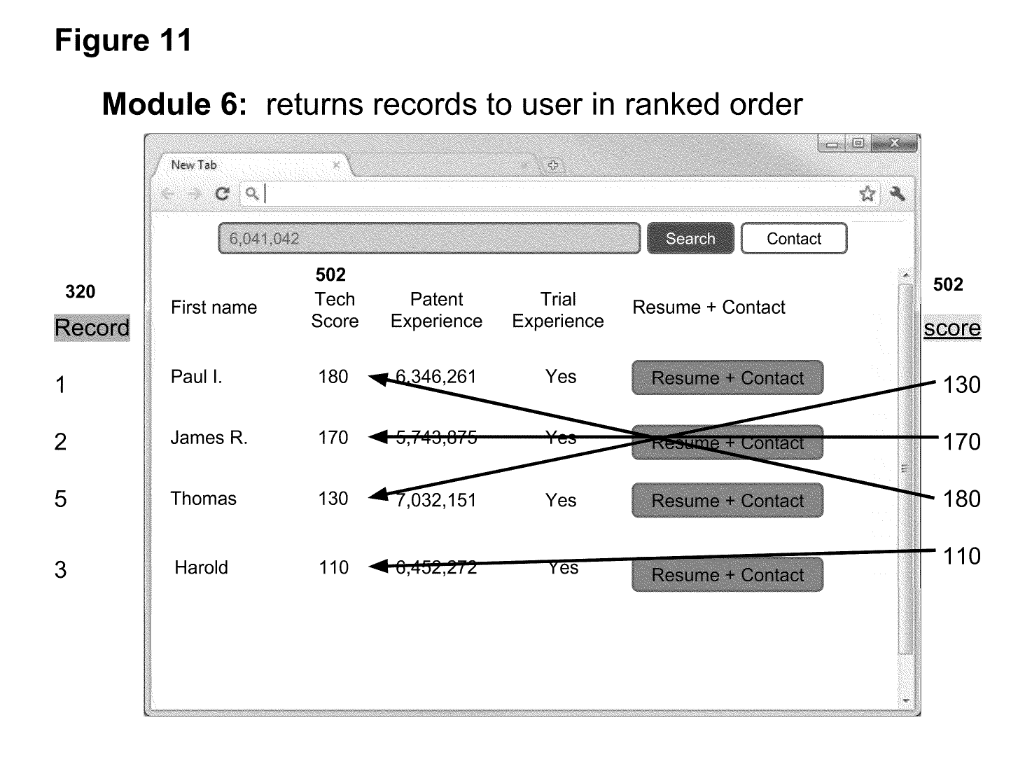

FIG. 11 is an illustration of an embodiment of a user interface that may be used for the record results and an identification of the record parameters items that may be used to determine the arrangement of the results. This relates to Module 6, which may return records in score order (600). In this illustration, the results on the web page in a browser, the records (320), are displayed in final score (502) order. In this embodiment, record one has a score of 180, record two has a score of 170, record five has a score of 130, and record 3 has a score of 110. Thus, the records are displayed in the order: 1, 2, 5, and 3.

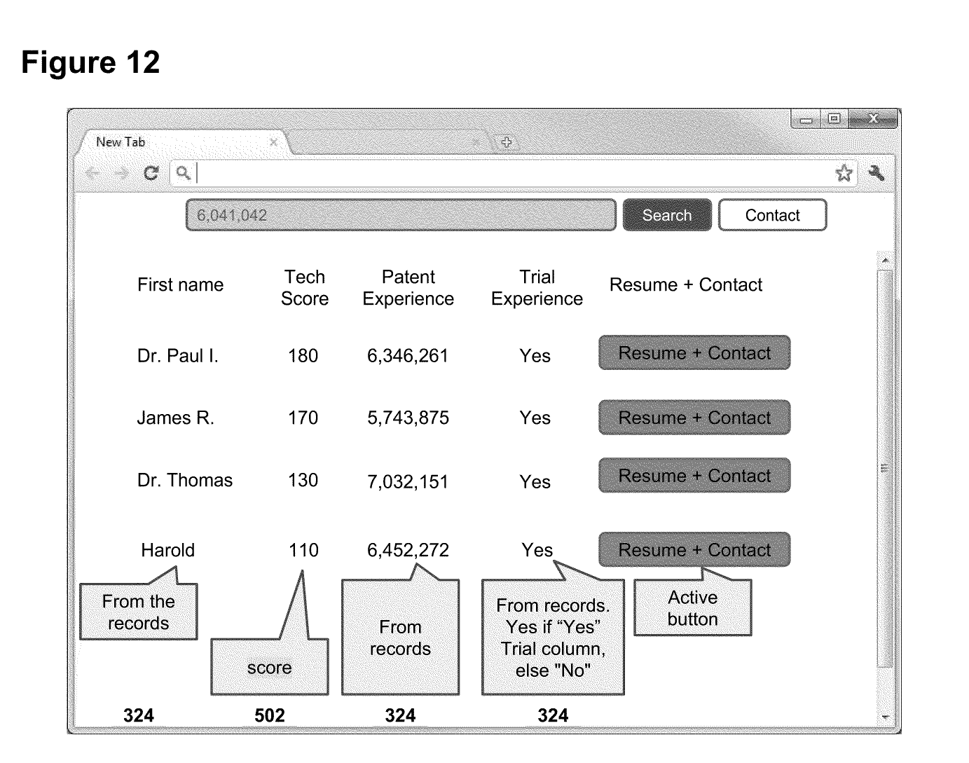

FIG. 12 is an illustration of an embodiment of a user interface that may be used for the record results and an identification of the record data parameters that may be used to display these results. On the results page, a module may be capable, via the application server and the web server, of retrieving data from the records database (310) and displaying this record metadata (324), along with the final score (502) for each record. The page also includes a link—here labeled resume+contact—that may be used to access additional record metadata (324).

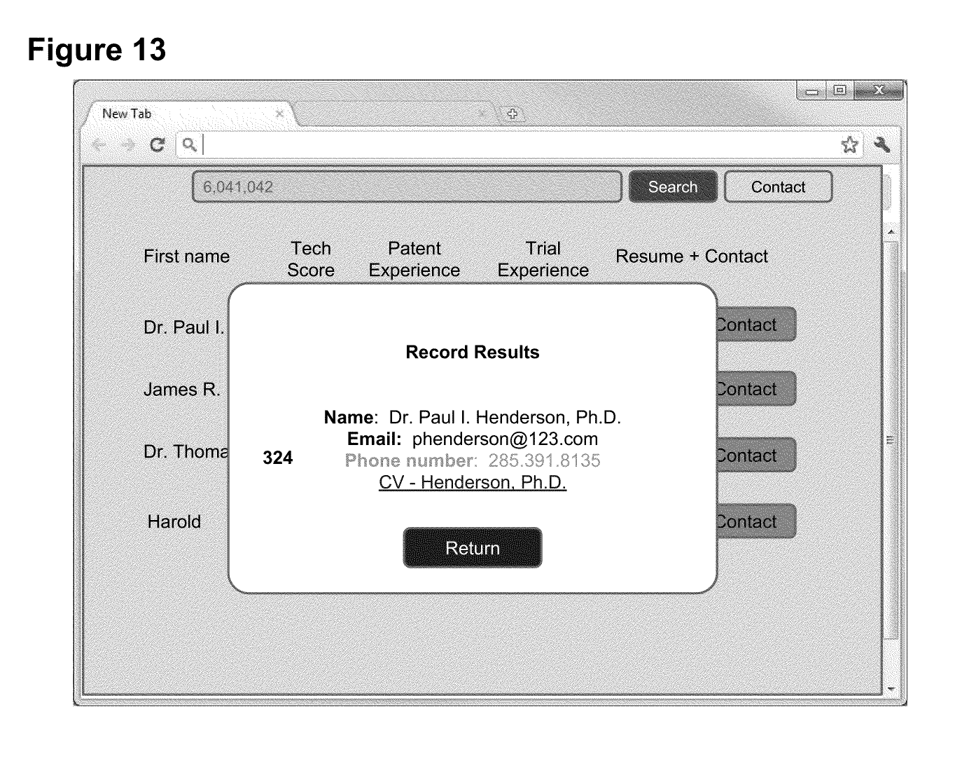

FIG. 13 is an illustration of an embodiment of a user interface that may be used for the record results and an identification of the record data parameters that may be used to display these results. In this display, a module may be capable, via the application server and the web server, of retrieving additional data from the records database (310) and displaying this record metadata (324).

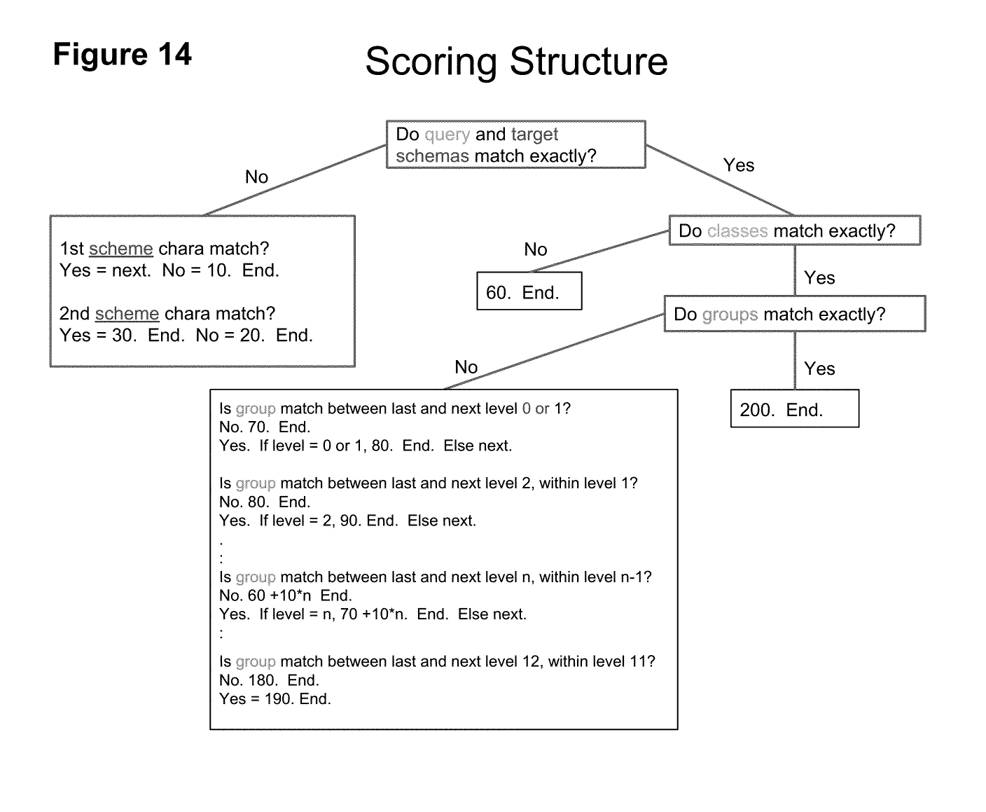

FIGS. 14-16 describe an embodiment that may be used for calculating a raw score (501) between a query CPC value (220) and a record CPC value (323).

FIG. 14 is a flowchart illustration of an embodiment showing a method that may be performed on two CPC values to determine a CPC score. Additional information about the CPC is available at http://www.cooperativepatentclassification.org/index.html.

The “section” is the first character and it is always alpha, A-H and Y. The “scheme” are the next three characters. The “class” are any and all remaining characters before the /. The “group” consists of all characters after the /. Each CPC value has included a level, which is a number that relates to its correspondence to the CPC values above and below it in the same scheme, class, or group. In this embodiment, but not shown in FIG. 14, if the section of query CPC (220) and the record CPC value (332) do not match, then that CPC pair may receive a raw score (501) of 0. If the schemas of the query CPC (220) and the record CPC value (332) do not match exactly, then a module may determine a raw score (501) based on how many characters of the schemas match, from left to right, with possible scores of 10, 20, and 30.

However, if the schemas of the query CPC (220) and the record CPC value (332) do match exactly, then a module may evaluate the classes. If the classes do not match exactly, then a module may give this CPC pair a score (501) of 60. If the classes do match exactly, then a module may evaluate the groups. If the groups match exactly, then this CPC pair may receive a score (501) of 200. If the groups do not match exactly, then a module may determine a raw score (501) based on the level of the query CPC compared to the location of the matching record CPC (or vice versa in an alternate embodiment).

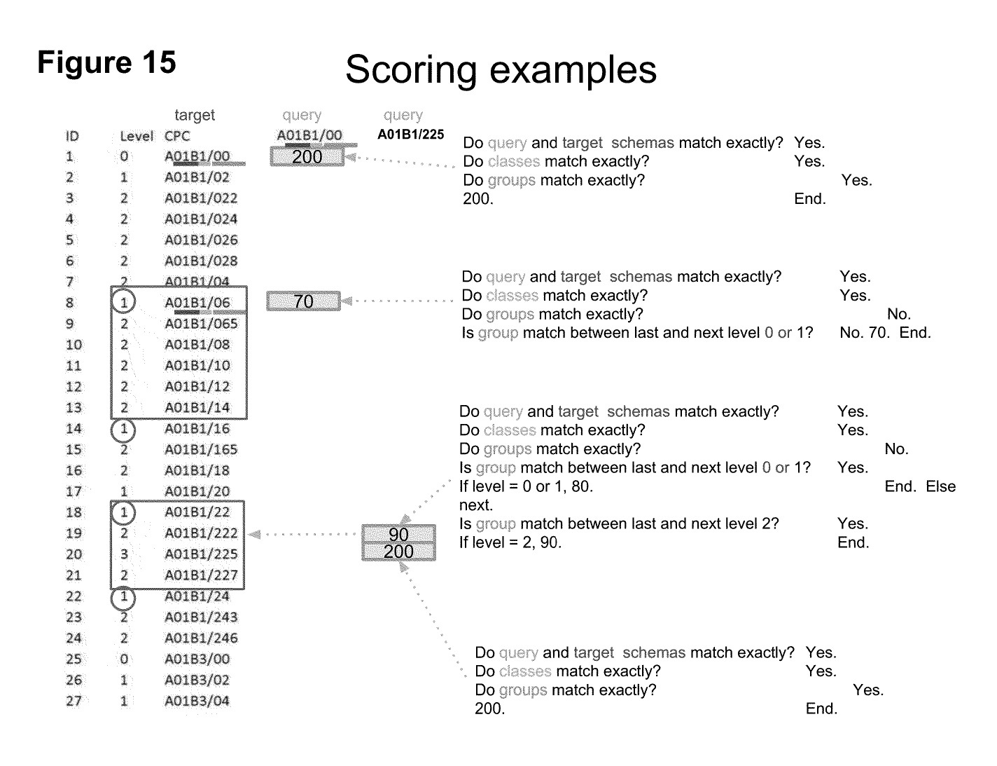

FIG. 15 is a diagram illustration of an embodiment showing a method that may be performed on two CPC values to determine a CPC score. These examples describe how to use one possible embodiment of determining a raw CPC pair score (501).

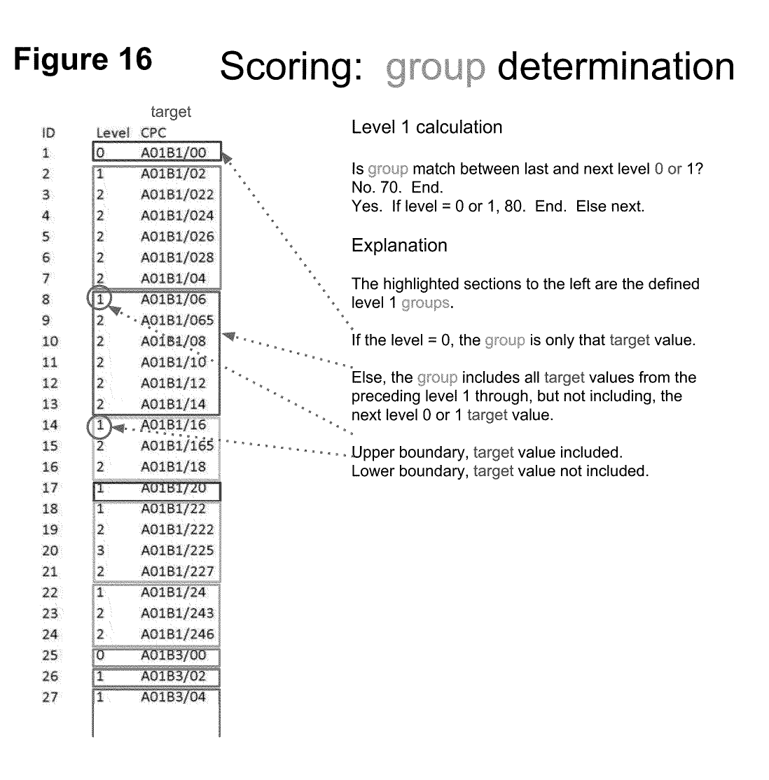

FIG. 16 is a diagram illustration of an embodiment showing a method that may be performed on two CPC values to determine a CPC score. This example describes additional details in illustration form of how to determine the raw score for the CPC pair (501) based on the level of the query CPC compared to the location of the matching record CPC.

Although the above description of FIGS. 14-16 disclosed specific values for the relationship between the query CPC value and record CPC value, it is also possible to use different values. These values may be influenced by a user, who may be an individual with significant experience in the intellectual property/patent industry (e.g. an industry expert). This user is capable of providing additional inputs and filters to modify how a module determines a value for the relationship between the query CPC value and record CPC value. In addition, a module may take into account additional information beyond CPC values to determine specific values for the relationship between the query CPC value and record CPC value, such as dates, billing rates, or other metadata associated with records pertaining to a query CPC value or record CPC value.

PSEUDO CODE FOR AN EMBODIMENT

```
1  Convert query patent number into CPC values (query CPC 1-n)
2  Convert case number(s) from record into CPC values (record n CPC
    (1-n)
3  Set record n score = 0
4  If query CPC letter = record CPC letter, goto line 6.
5  Else query CPC n, record n score = 0
6  Score query CPC to record CPC
7  If score > record n score, then record n score = score
8  Else, goto next
9  Loop lines 4-8 until each query CPC scored against each record CPC
    in record n
10  Save record n score; goto next record
11  Loop lines 3-10 until all records are scored.
12  Sort all records from largest to smallest score
13  Output records in score order to results page of website
```

### Embodiments can use Other Relevancy Techniques

As an example of the system and method described herein, embodiments have been provided above that used a form of classification to determine the relevancy between an input and an expert. However, there are many other ways to generate a relevancy between two objects, and many of these techniques can be used in combination with each other or may be implemented as disparate aspects of the system and method described herein and then combined at the end to generate a final relevancy score.

Although there are many techniques known in the fields of information retrieval, relevancy algorithms, and machine learning, the following describes specific concepts and techniques that can be used by the system and method described herein.

For example, these issues may be generally grouped in the following sets: Classification, Clustering, Regression, Anomaly detection, Association rules, Reinforcement learning, Structured prediction, Feature learning, Online learning, Semi-supervised learning, and Grammar induction.

Specific examples of supervised learning (via classification and regression) including using Decision trees, Ensembles (Bagging, Boosting, Random forest), k-NN Linear regression, Naive Bayes (including text classification), Neural networks, Logistic regression, Perceptron, Support vector machine (SVM), or Relevance vector machine (RVM). Additionally, the system and method may use clustering techniques, such as BIRCH, Hierarchical k-means, Expectation-maximization (EM), DBSCAN, OPTICS, and Mean-shift. To reduce the dimensionality of search problem, the system and method may use at least the following techniques Factor analysis, CCA, ICA, LDA, NMF, PCA, and t-SNE. Because some of the individuals, patents, and patent meta-data may be stored in a highly structured format, the system and method may use at least the following techniques: Graphical models (Bayes net, CRF, or HMM). To reduce incidence of anomalies in the results, the system and method may use at least the following techniques: k-NN or Local outlier factor. Additionally, the system and method may use neural nets to estimate or approximate functions that may depend on a large number of inputs or are generally unknown. To perform this task, the system and method may use at least the following techniques: Autoencoder, Deep learning, Multilayer perceptron, RNN, Restricted, Boltzmann machine, SOM, or a Convolutional neural network.

By way of example, one technique that has been implemented into one working example of one embodiment of the system and method described herein uses SimRank to find the relevancy between a set of records (for example between a set of patents). SimRank is described in further detail in the following two publications, both of which are incorporated herein by reference: SimRank: A Measure of Structural-Context Similarity by Glen Jeh and Jennifer Widom, available at http://ilpubs.stanford.edu:8090/508/1/2001-41.pdf and A Space and Time Efficient Algorithm for SimRank Computation by Weiren Yu, Wenjie Zhang, Xuemin Lin, Qing Zhang, and Jiajin Le, available at http://www.cse.unsw.edu.au/˜zhangw/files/wwwj.pdf.

By way of example, another technique that has been implemented into one working example of one embodiment of the system and method described herein uses simulated annealing to optimize the parameters in a variety of search technique (for example the best parameters and weights for the classification technique described above). Simulated annealing is described in further detail in the following publications, which is incorporated herein by reference: Simulated Annealing by Dimitris Bertsimas and John Tsitsiklis, available at http://www.mit.edu/˜dbertsim/papers/Optimization/Simulated%20annealing.pdf.

By way of example, another technique that has been implemented into one working example of one embodiment of the system and method described herein uses Naive Bayes to analyze the text of a patent documents, or a subset of the text, to determine the relevancy between two or more patents (for example a query patent and one or more patents in an expert witnesses record). Naive Bayes is described in further detail in the following publications, which is incorporated herein by reference: Generative And Discriminative Classifiers: Naive Bayes And Logistic Regression by Tom M. Mitchell, available (in draft form) at http://www.cs.cmu.edu/˜tom/mlbook/NBayesLogReg.pdf.

### Embodiments can Apply to Other Relevancy Areas

The system and method described above may involve matching a search query of a patent to a record of a patent expert, which also may include patent(s). However, there are many other ways to use the system and method described herein to generate a relevancy between two objects. Additional embodiments are described above (e.g., areas of use and relevancy techniques) and below (e.g., data used to calculate a relevancy score).

Another embodiment may involve the area of matching new patent matters to the records of patent attorneys to help attorneys find new cases that they can pitch for or to help in-house counsel, and their company, find, rank, and determine a suitable attorney to hire for the matter. Currently, there are about 6,000 new patent lawsuits filed each year, and a continuously growing number of proceedings filed at the ITC (enforcement proceeding) and at the PTAB (IPR, CBM, etc.)

The below embodiment illustrates finding an attorney for an accused infringer based on a new patent lawsuit filed in a district court and profiles of attorneys, where the profile includes their prior patent lawsuit experience in a district court. However, it should be understood that the search query can be other types of matters: ITC proceedings, PTAB proceedings, patent owner's search for an attorney, a licensing search, and—at least—all of the other use cases describes above.

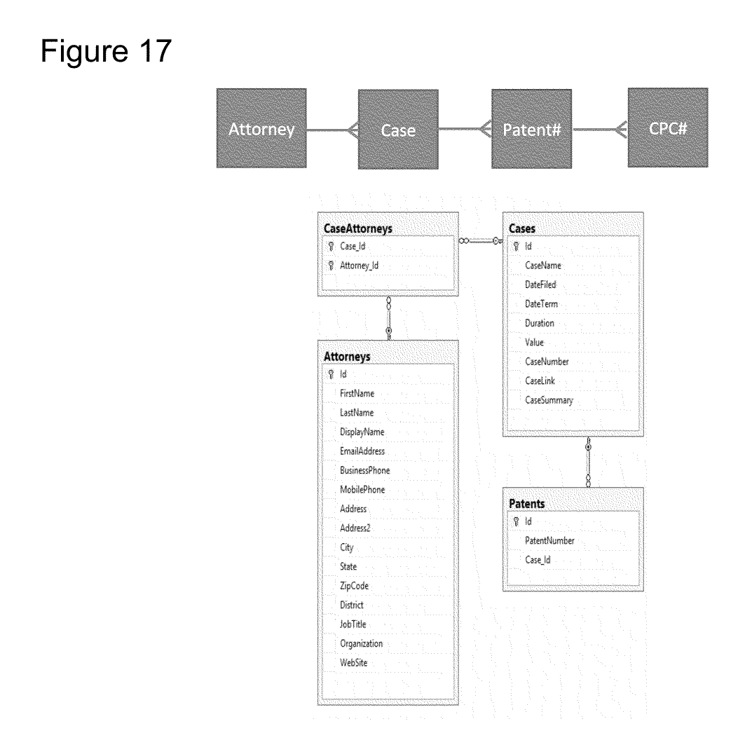

FIG. 17 is a flowchart illustration of an embodiment showing a method of analyzing attorney, case, and patent data (top). When a new case is file in a U.S. District Court, the complaint must identify the patent numbers-in-suit. These numbers may act as the search query (alternatively, the patent numbers in an attorney's profile can be the search query) and each attorney in the system may act as the records for analysis. The below indented structure outlines the steps the system may take to determine a rank, relevancy, and final score for an attorney as compared to the new case (or amended complaint or counterclaim with new parties or new patents).
(1) For each attorney
(2)—For each case of the attorney
(3)—For each patent of the case
(4)—For each CPC of the patent
(5)—For each CPC of the Query patent
(6)—Calculate score
(7)—Calculate patent score (avg. or sum of top X CPC scores)
(8)—Calculate case score (avg. or sum of top Y patent scores)
(9)—Calculate attorney score (avg. or sum of top Z case scores)

In this embodiment, the system first may pull the data (in parallel or serially) for each attorney. Second, the system may pull the data (in parallel or serially) for each case in which the attorney filed an appearance as an attorney of record. The system may also allow an attorney to associate their profile with a case even if they did not file an appearance in the case. One example is when an attorney works on a case by supporting another attorney that has field an appearance in the case. Third, the system may pull the data (in parallel or serially) for each patent in each case in the attorney's profile. Fourth, the system may pull the data (in parallel or serially) for each CPC value of each patent in the attorney's profile.

Fifth, the system may pull the data (in parallel or serially) for each CPC value of each patent in the patent-in-suit. These CPC values may be obtained directly from the USPTO, from USPC classification data and then converted to CPC value via proprietary algorithm or via the USPTO's statistical mapping tools. For each CPC pair (from the attorney's profile and from the new case) the system may calculate a relevancy score.

By way of example, this score may take into account relationship between the two values, as describes above using the structure of the CPC values as a guide to determining a score, or via one of many other machine learning tools (including SimRank, rule based reasoning, clustering, case based reasoning, or any other the other techniques described above). This relevancy may alternatively be calculated at the patent level. For example, using SimRank and the prior art cited on the face of an issued application as the links between patents.

Returning to the embodiment shown in FIG. 17, and described in one manner in indented steps above, in the sixth step the system may sum multiple CPC scores to determine a score for each patent. This process may also include weighting CPC pairs. Seventh, the system may sum multiple patent scores to determine a score for each case. Eighth, the system may sum multiple case scores to determine a score for each attorney.

After this process is complete for each patent-in-suit, a final score for each attorney may be determined. This final score may form an accurate representation of each attorney's experience with cases and patents similar to the case and patents-in-suit. As a result by ordering, clustering, or otherwise sorting the results, the relevancy of each attorney (or group of attorneys, or firm) may be determined and displayed.

FIG. 17 also displays an embodiment of a database schema showing how case, attorney, and patent data may be stored in a database so it may later be retrieved and then analyzed (bottom). This embodiment is one way to store some of the information necessary to perform the described herein.

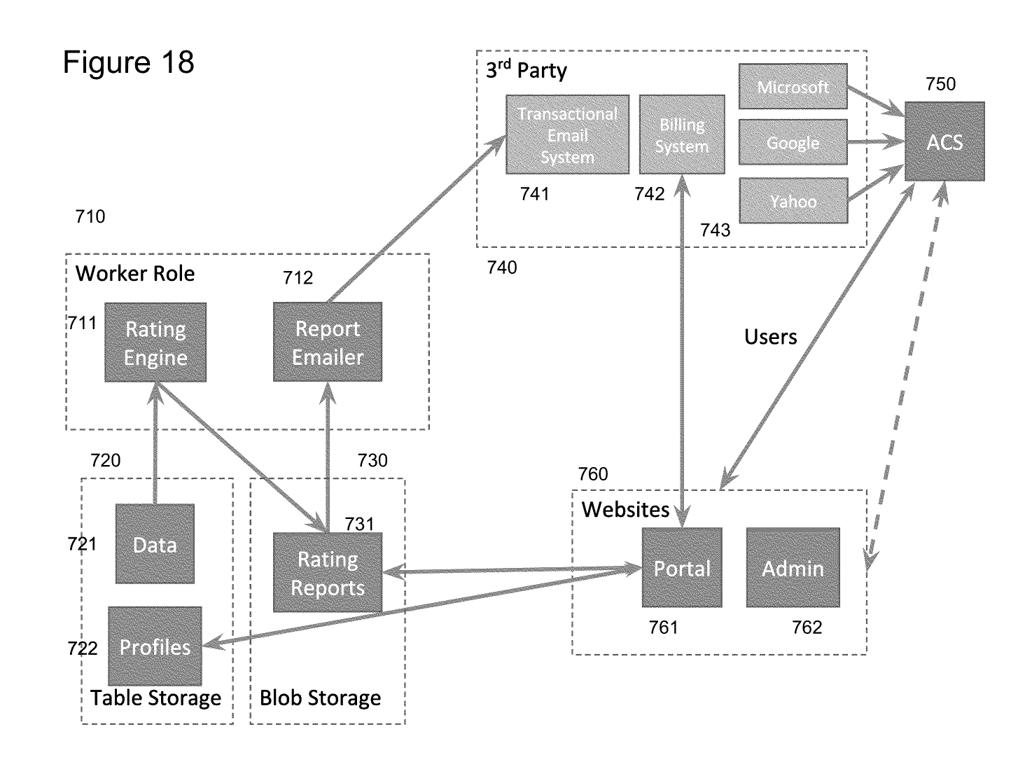

FIG. 18 is a diagram illustration of an embodiment showing a system and method of a search system, which may be integrated with a report generation module, email module, billing module, or a frontend user website. In one possible embodiment, the Worker Role (710) may have two modules: a Rating Engine (711) and a Report Emailer (712). The Rating Engine (711) may calculate the scores, such as via a variety of processes and using a variety of weights for the parameters. The Report Emailer (712) may receive the data necessary to generate a report in email form and may provide it to a Third Party Systems (740), such as a Transactional Email System (741).

The Table Storage (720) may store a variety of data types. For example, some Data (721) includes: classification data, (new and prior) case data, and patent data. Other data may be related to the attorney Profiles (722). This data may be stored in a variety of forms and format, such as on one server, in a cloud server, or across multiple cloud serves from different providers, and in a relationship SQL database, a NOSQL database, etc. This data may be fed into the Rating Engine (711) so scores may be calculated using this data.

The Blob Storage (730) may store the results from the Rating Engine (711). These results may be further processed (at this stage) as a Rating Report (731) or when the data is passed to the Report Emailer (712). During post processing, summary data may be extracted and formatted properly so it can be sent to a Third Party Systems (740), such as a Transactional Email System (741). This processing may include extracting (or calculating) a final score for each attorney, their rank, relevancy, most relevancy case, and most relevant patent for a giving input newly filed case.

Additionally, in one possible embodiment, this data may be based on comparing one attorney to all other attorney in the system, thus producing a global report. Alternatively, multiple attorneys may be grouped, for example by their law firm associations, so one group may be ranked against all other similar groups (e.g. ranking one law firm against all other law firms). As a further embodiment, the data may be filtered so only some attorney or groups of attorneys are included in the ranking process. For example, a filter may be run on the district of the newly filed case and only attorneys that live in that district, or have appearance in a certain number of patent cases in that district, will be included in the analysis. For example, if a new case was filed in the Northern District of Illinois, this post processing may be filtered to only include attorneys that live, or have an office, in the Northern District of Illinois (such as attorneys from Chicago, Ill.) or attorneys that have been involved with three patent cases in the Northern District of Illinois even though they may live in a different location.

Several Third Party Systems (740) may also interact with the embodiments described herein. For example, a Transactional Email System (741), like Mandrill by MailChimp, may receive the data from the Report Emailer (712), format the data, and then send it to users so they may receive and review the reports. Additionally, a Billing System (742) may be integrated with the system so invoices, recurring credit card transactions, or other monetization services may be utilized. Also, Search and Marketing Channels (743), such as Bing by Microsoft, Google Search, Yahoo! Search, LinkedIn, Facebook, or other services may be used to bring users to the service.

A user, via a client's system, ACS, (750) may then interact with the Websites (760). In particular, one website, Portal (761), may assist with obtaining more detailed information (or a different filtered view) or the reports from Rating Reports (731). Or the user may modify their Profile (722), including making changes to their billing information, which may be stored by the Billing System (742). In addition to a user Portal (761), there may also be a website for the Administrator (762). This site may change the parameters, search processes, weights, or other aspects of the system. This site may also allow the admin to set the time of delivering of emails, resending emails, generating custom reports based on the Rating Reports (731), or modifying the Data (720), for example because there is new data or the data has an error.

### Additional Embodiments

While the forms of the invention disclosed in this specification constitute presently preferred embodiments, many others are possible. It is not intended herein to mention all of the possible equivalent forms or ramifications of the invention. It is understood that the terms used herein are merely descriptive rather than limiting, and that various changes may be made without departing from the spirit or scope of the invention.

Several examples of these other embodiments are listed below, and can be applied to the above describes about a query, a record, and scoring.

Data parameters that can be analyzed and used by a module capable of scoring may include: U.S. Classification (USPC) data, International Classification data, European Classification data, any other countries or NGOs (including private corporation) patent classification data, educational degree or certification data, or inventor/assignee data, or combinations of these.

Data parameters that can be analyzed and used by a module capable of query and record analysis, as a filter to modify how a score is applied to records, and/or used as data that can be displayed to the user include the following, which may constitute metadata as described above:

| Type | Query, Filter, or Record |
|---|---|
| Patent | 130(b) Affirmation Flag, 130(b) Affirmation Statement, |
| | Abstract, Applicant City, Applicant Country, Applicant |
| | Name, Applicant State, Applicant Type, Application |
| | Date, Application Serial Number, Application Type, |
| | Assignee City, Assignee Country, Assignee Name, |
| | Assignee State, Assistant Examiner, Attorney or Agent, |
| | Certificate of Correction, Claim(s), Current CPC |
| | Classification, Current CPC Classification Class, |
| | Current US Classification, Description/Specification, |
| | Foreign Priority, Foreign References, Government Interest, |
| | International Classification, Inventor City, Inventor |
| | Country, Inventor Name, Inventor State, Issue Date, Other |
| | References, Parent Case Information, Patent Family ID, |
| | Patent Number, PCT 371cl24 Date, PCT Filing Date, PCT |
| | Information, Primary Examiner, Prior Published Document |
| | Date, Priority Filing Date, PTAB Trial Certificate, |
| | Re-Examination Certificate, Referenced By, Reissue |
| | Data, Reissued Patent Application Filing Date, Related |
| | Application Filing Date, Related US App. Data, |
| | Supplemental Exam Certificate, Title, or keywords |
| | about a patent. |
| Case | Case number, nature of suit code, judges name, |
| | magistrate judges name, court/agency, pleading name, |
| | pleadings, filing dates, case status, remedy types, |
| | party names, counsel firm names, counsel names, names |
| | of experts (consulting and testifying), names of |
| | court reporters, names of vendors (graphics, speech, |
| | jury consultant, etc.), or keywords about a case. |
| Education | Name of educational institution (associate, bachelors, |
| | masters, doctoral, professional, post-graduate, |
| | post-doctoral), year of matriculation, year of |
| | graduation, degree earned, thesis (title description, |
| | text), or keywords about education. |
| Literature | Published and unpublished articles, the names of the |
| | publishing entity, the date of the article, the field |
| | of the publication, or keywords about literature. |
| Biographical | Employment history, professional experience, |
| | certifications, age, name, contact information, |
| | resume/CV information, unique ID, language, culture, |
| | place of residence history, gender, physical appearance, |
| | style of dress, mannerisms, professional reputation, |
| | voice (pitch, volume, timbre, tone and other quality |
| | attributes), or keywords about biographical information. |
| Time/money | Billing rate, prior compensation earned, availability |
| | to work, availability for an interview, hours spend |
| | on prior projects, or keywords about time and money |
| | factors. |

As with the presently disclosed preferred embodiments, these sample data parameters for the query, records, and scoring are not the only ones possible. It is not intended herein to mention all of the possible equivalent forms or ramifications of these parameters. It is understood that these parameters are merely descriptive rather than limiting, and that various changes may be made without departing from the spirit or scope of these parameters and the invention.

### Conclusion

The embodiments described above are intended only to illustrate and teach one or more ways of practicing or implementing the present invention, not to restrict its breadth or scope.

1. A non-transitory computer-readable medium for establishing measures of relevancy between information relating to patents, comprising instructions stored thereon, that when executed on a processor, perform the steps of:
a. receiving an electronic communication containing a patent number query;
b. converting the patent number query into a first parameter for analysis, wherein the first parameter for analysis is a first Cooperative Patent Classification value;
c. accessing a record database, wherein the record database contains a first record, and wherein the first record is associated to information about patents;
d. converting the information about patents into a second parameter for analysis, wherein the second parameter for analysis is a second Cooperative Patent Classification value;
e. performing an analysis of relevancy between the first Cooperative Patent Classification value and the second Cooperative Patent Classification value; and
f. associating a score to the first record that is related to the relevancy between the first Cooperative Patent Classification value and the second Cooperative Patent Classification value.

2. The non-transitory computer readable medium according to claim 1, wherein the score is based on a level of a query Cooperative Patent Classification group value and a level of a record Cooperative Patent Classification group value.

3. A system for establishing measures of relevancy between information relating to patents, comprising:
a. a web portal component capable of receiving an electronic communication containing a patent number query;
b. a storage component containing a records database that is capable of:
i. converting the patent number query into a first group of parameters for analysis, wherein the first group of parameters for analysis are query Cooperative Patent Classification values, wherein each query Cooperative Patent Classification value has a rank of either primary or secondary;
ii. receiving a selection of a type of record for analysis;
iii. accessing the record database, wherein the record database contains the selected type of records for analysis, and wherein the type of record for analysis is associated to information about patents; and
iv. converting the information about patents into a second group of parameters for analysis, wherein the second group of parameters for analysis are record Cooperative Patent Classification values, wherein each record Cooperative Patent Classification value has a rank of either primary or secondary; and
c. a rating engine component capable of:
i. associating a raw score to each pair of query Cooperative Patent Classification and record Cooperative Patent Classification values based on an analysis of the relevancy between each pair of query Cooperative Patent Classification and record Cooperative Patent Classification values;
ii. associating a modified score to each pair of query Cooperative Patent Classification and record Cooperative Patent Classification values by modifying the raw score for each pair of query Cooperative Patent Classification and record Cooperative Patent Classification values based on the status of the query Cooperative Patent Classification value rank or the record Cooperative Patent Classification rank; and
iii. associating a final score to each record that is related to the highest modified score for each record.

4. A non-transitory computer-readable medium for establishing measures of relevancy between information relating to patents, comprising instructions stored thereon, that when executed on a processor, perform the steps of:
a. receiving a query, wherein the query includes at least one of a patent number, a patent publication number, a patent serial number, a case number of a lawsuit that alleges infringement of a patent, a name of an expert that has opined about a patent, a name of a lawyer that provided patent advice;
b. converting the query into a first group of parameters for analysis, wherein the first group of parameters for analysis are at least one of query Cooperative Patent Classification values, query USPC values, query EC values, or query IC values;
c. receiving a selection of a type of records for analysis, wherein the selection includes at least one of testifying expert witness records, consulting expert witness records, patent litigation attorney records, patent prosecution attorney records, patent prosecution agent records, or patent licensing attorney records;
d. accessing a record database, wherein the record database contains the selected type of records for analysis, and wherein the type of records for analysis are associated to information about patents;
e. converting the information about patents into a second group of parameters for analysis, wherein the second group of parameters for analysis are the same type of parameters for analysis as the query parameter for analysis;
f. associating a raw score to each pair of query and record parameter for analysis based on an analysis of the relevancy between each pair of query and record parameter for analysis; and
g. associating a final score to each record that is related to the raw scores for all of the query and record parameter for analysis associated to that record.

5. The non-transitory computer readable medium according to claim 4, wherein the query is a patent number.

6. The non-transitory computer readable medium according to claim 4, wherein the type of records for analysis are testifying expert witness records.

7. The non-transitory computer readable medium according to claim 4, wherein the parameters for analysis are query Cooperative Patent Classification values.

8. The non-transitory computer readable medium according to claim 4, wherein the parameters for analysis are query Cooperative Patent Classification values and wherein the raw score is based on an exact match between a query Cooperative Patent Classification section value and a record Cooperative Patent Classification section value.

9. The non-transitory computer readable medium according to claim 4, wherein the parameters for analysis are query Cooperative Patent Classification values and wherein the raw score is based on an exact match between a query Cooperative Patent Classification scheme value and a record Cooperative Patent Classification scheme value.

10. The non-transitory computer readable medium according to claim 4, wherein the parameters for analysis are query Cooperative Patent Classification values and wherein the raw score is based on an exact match between a query Cooperative Patent Classification class value and a record Cooperative Patent Classification class value.

11. The non-transitory computer readable medium according to claim 4, wherein the parameters for analysis are query Cooperative Patent Classification values and wherein the raw score is based on an exact match between a query Cooperative Patent Classification group value and a record Cooperative Patent Classification group value.

12. The non-transitory computer readable medium according to claim 4, wherein the parameters for analysis are query Cooperative Patent Classification values and wherein the raw score is based on a level of a query Cooperative Patent Classification group value and a level of a record Cooperative Patent Classification group value.

13. The non-transitory computer readable medium according to claim 4, further comprising the step of displaying record information in the order of the final score of each record.

14. The non-transitory computer readable medium according to claim 4, further comprising the step of displaying record information in the order of the final score of each record, wherein the record information includes a name of the individual associated to the record.

15. The non-transitory computer readable medium according to claim 4, further comprising the step of displaying record information in the order of the final score of each record, wherein the record information includes a piece of contact information associated to the record.

16. The non-transitory computer readable medium according to claim 4, further comprising the step of receiving a request for authentication before displaying any record information.

17. The non-transitory computer readable medium according to claim 4, further comprising the steps of receiving a selection of a form of payment in exchange for accessing the record database, wherein the form of payment includes one of referring new users, paying per query, paying per record information accessed, paying per record contacted wherein the record relates to an individual, paying per contact wherein the record relates to an individual and the individual signs a contract as a result of record information associated to the individual being displayed, and paying per invoice wherein the record relates to an individual and the individual issues invoices as a result of record information associated to the individual being displayed.

18. The non-transitory computer readable medium according to claim 4, further comprising the step of initially only displaying some information about record until a user is granted access to the record database.

19. The non-transitory computer readable medium according to claim 4, further comprising the step of accessing the record database via a secure connection.

20. The non-transitory computer readable medium according to claim 4, further comprising the step of delaying the display of information from the records database for at least four seconds from the time the query is received.
